(19) United States
(12) Patent Application Publication
(10) Pub. No.: US 2013/0082212 A1
(43) Pub. Date: Apr. 4, 2013

(54) Consolidation Methodologies for Semiconductor Nanomaterials

(71) Applicant: Evident Technologies, Troy, NY (US)

(72) Inventors: Clinton T. Ballinger, Burnt Hills, NY (US); Susanthri Perera, Cohoes, NY (US); Adam Z. Peng, Schenectady, NY (US)

(73) Assignee: EVIDENT TECHNOLOGIES, Troy, NY (US)

(21) Appl. No.: 13/644,491

(22) Filed: Oct. 4, 2012

Related U.S. Application Data
(60) Provisional application No. 61/543,013, filed on Oct. 4, 2011.

(51) Int. Cl. H01B 1/02; C09C 3/04

(52) U.S. Cl. CPC H01B 1/02; C09C 3/04; Y10S 977/773; B82Y 30/00
USPC 252/500; 264/104; 977/773

(57) ABSTRACT

Embodiments of the invention relate generally to methods of consolidating semiconductor nanomaterials. In one embodiment, the invention provides a method of consolidating a material comprising: mixing a population of semiconductor nanocrystals with a matrix material and a solvent; heating the mixture to remove the solvent; and consolidating the semiconductor nanocrystals and the matrix material into a consolidated material

### CROSS-REFERENCE TO RELATED APPLICATIONS

This application claims the benefit of co-pending U.S. Provisional Application Ser. No. 61/543,013, filed 4 Oct. 2011, which is hereby incorporated by reference herein.

### FIELD OF THE INVENTION

The present invention relates generally to a method of consolidating nano-sized semiconductor materials into a mechanically stable electronic material.

### BACKGROUND OF THE INVENTION

Many researchers have studied nanomaterials for their compelling properties. Nanomaterials have the promise of additional tunability, over traditional bulk materials, of the electronic band structure due to the nature of their quantum confined band structure. Unlocking the true potential of these materials is often impractical as the quantum confined properties have previously been tied to the material in a thin film format of nanometer sized dimensions.

Colloidally grown semiconductor nanocrystals have been studied for years but have not seen widespread use in many applications, especially electronic applications. One of the major drawbacks for using colloidally grown quantum dots is that they are grown in a solution and have persistent surface ligands that can be very difficult to clean. The number of surface molecules on each surface of a quantum dot will impact the final electronic material and may act as an unwanted contaminant within the system.

Previous attempts to utilize quantum dots have included a method to consolidate nanomaterials into a macro structure utilizing hot pressing of a nanomaterial powder which has been ground to nano-size into a monolithic material. Another previous attempt utilized spark plasma sintering as a consolidation process. Both of these methods have drawbacks, one of which is that it is very difficult to control the grain growth on a nano-scale material when applying the previous heat and pressure parameters needed to consolidate most powders. Temperatures have been in excess of 200° C., which are typical for both of these methods, and often include very high pressure, which may be on the order of tons. These methods lead to significant grain growth, which can detract from the inherent nanostructure properties, as the grains are no longer within the nanometer size regime.

Previous methodologies have not been able to produce a broad range of materials. For instance, milling the material to a fine powder does not result in quantum confined structures. Further, using epitaxial methods to create nano-thin layers that do possess quantum confinement effects cannot be fashioned into a macro structure with a thickness that is typical for most electronic applications, such as at least 10 microns.

### SUMMARY OF THE INVENTION

The present invention relates generally to a method and a consolidated material which includes nanocrystals and a material that acts as a molecular glue. The molecular glue can act as a glue between the nanocrystals during the consolidation of the material, or between other particles included within the consolidated material. One such molecular glue includes a higher concentration than typical stoichiometry of at least one atomic species, perhaps on the surface of the nanocrystals, that can act as a molecular glue between the nanocrystals, larger agglomerated particles, or larger crystals of similar semiconducting materials.

A first aspect of the present invention includes a method of consolidating a material comprising: mixing a population of semiconductor nanocrystals with a matrix material and a solvent; heating the mixture to remove the solvent; and consolidating the semiconductor nanocrystals and the matrix material into a consolidated material.

A second aspect of the present invention includes a consolidated material, the consolidated material comprising: a population of semiconductor nanocrystals; and a matrix material.

### DETAILED DESCRIPTION OF THE INVENTION

The present invention can utilize semiconductor nanocrystals that have quantum confined nanomaterial properties. Methods according to some embodiments of the invention result in a typical size of the constituent crystals being less than or approximately equal to the exciton Bohr radius of the material system. The nanomaterials can be consolidated into a monolithic material of a macro dimension, for example greater than a few microns, by a variety of techniques disclosed herein.

Embodiments of the invention provide methods for forming a macro material, such as a micrometer sized material, that retains the material properties inherent to the nanometer sized starting materials. Typically, those skilled in the art of consolidating materials may use an inert environment or vacuum to press these materials. This can help prevent oxidation of the material. Nanocrystal powders are notoriously easy to oxidize since they possess such high surface to volume ratios. Oxidation of the material can remove many of the quantum confinement properties of the material. However, a controlled amount of oxidation may prove useful in that it may help to impede grain growth, which can help to retain the nanostructure of the material and may help with other properties, such as electron filtering, which leads to a larger Seebeck coefficient, and a partial decoupling of the electrical conductivity from the Seebeck coefficient.

If the surface of the nanocrystal or the agglomerated material is not completely oxidized, then the material may have enhanced electrical conductive properties upon consolidation of the material. The portions of the material that are free of oxides can form a conductive pathway for electrons. This may be further enhanced with the use of an electric current during the consolidation process. In fact, the material may undergo local heating at the interface, which could result in developing a more significant bond between the materials.

According to certain embodiments of the present invention, a number of different consolidation methodologies are presented, as well as a methodology where the final consolidated material has anisotropic properties which lead to a performance enhancement.

According to one embodiment, a method involves using a molecular glue to create a monolithic material. In this instance, a monolithic material means a solid material constructed from these non-sized starting particles. Typically, this includes a material that has consistent material properties on the macro scale, but the nanoscale may have variations in properties and makeup. It does not necessarily have to be a well ordered system, but is generally a solid material that is a result of consolidating the smaller constituent starting materials. In such an embodiment, a dried powder of nanocrystals may be utilized, with another material used as a glue molecule to help bind the nanocrystals. The molecular glue may be, in some instances, another type of nanocrystal, a molecule, an atom, a conductor, an insulator, a semiconductor, a semimetal, an organic linker, or other similar materials.

In one embodiment, a particular type of nanocrystals may be obtained. Examples of such materials may include, for instance, AlX(X═N,P,As), Ag, Au, Bi, Co, Cu, Fe, Pt, Pd, Ru, Rh, Si, Sn, Ni, Ge, GaX(X═N,P,As,Sb), CuX(X═S,Se,InSe2), PbX(X═S,Se,Te), InX(X═P,As,Sb), ZnX(X═S,Se,Te), HgX(X═S,Se,Te), GeSe, CoPt, CuInGa(Se,Se)₂, Cu₂XnSn(S,Se)₄, BiX(X═S,Se,Te), CdX(X═S,Se,Te), or any combination of these materials. In some instances, these nanocrystals could be synthesized. In some embodiments, a plurality of different types of nanocrystals may be utilized. If the nanocrystals are synthesized, the nanocrystals may then be cleaned. In either case, the nanocrystals can then be mixed with a molecular glue, which in some cases may be nanometer sized materials, molecules, or atomic species. Examples of such materials may include nanocrystals or ball milled bulk powders such as Sb₂X₃(X═S,Se,Te), Sn₂X₃(X═S,Se,Te), ZnTe, In₂Se₃, In₂Te═, CuInSe₂, CuInGaSe₂, and Zintl ions such as AS₃³⁻, As₄²⁻, As₅³⁻, As₇³⁻, As₁₁³⁻, AsS₃³⁻, As₂Se₆3-, As₂Te₆³⁻, As₁₀Te₃²⁻, Au₃Te₄³⁻, Bi₃³⁻, Bi₅³⁻, Bi₇³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Bi₅²⁻, Pb₇⁴⁻, Pb₉⁴⁻, Pb₂Sb₂²⁻, Sb₃³⁻, Sb₄²⁻, Sb₇³⁻, SbSe₄³⁻, SbTe₄⁵⁻, Sb₂Se³⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se₆²⁻, Sn₄²⁻, Sn₅²⁻, Sn₉³⁻, Sn₉⁴⁻, SnS₄⁴⁻, snTe₄⁴⁻, SnS₄Mn₂⁵⁻, Sn₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, or other nanocrystals or powders that may act as an appropriate material when combined with BiSbTe or similar nanocrystals to form the final material. Other examples may include Bi, Sb or Te atomic residue that may eventually act as a molecular glue between other nanoparticles when it is consolidated together.

The molecular glue may be suspended in solution, for instance in hydrazine, in order to form an outer coating. These nanomaterials could then, subsequent to mixing, all be suspended in hydrazine. The resulting material can be dried into a nanoscale agglomerated powder. This drying may result in randomly sized groupings of nanocrystals, with the molecular glue as interstitial molecules. Such a powder may be used as the starting point for subsequent consolidation methods as described herein. Other nanocrystal powders may be utilized. However, for brevity, this same powder will be used in the descriptions.

More details will be clear in the examples described below.

### EXAMPLE

BiSbTe Material Example

In one embodiment, BiTe nanocrystals with SbTe/Te-hydrazine are utilized. Nanocrystals of BiₓSb₍₂₋ₓ₎Te_{3+Δ} (x approx. 0.5 and Δ+/−0.5) are synthesized by mixing the two aforementioned species, and then cleaned and mixed with SbTe in hydrazine to form an outer coating. These nanomaterials can be suspended in hydrazine. The material can be dried into a nanoscale agglomerated powder with randomly sized groupings of nanocrystals and SbTe interstitial molecules. Such a powder may be used as the starting point for subsequent consolidation methods as described herein. Other nanocrystal powders may be utilized. However, for brevity, this same powder will be used in the following descriptions.

The above dry powder, or other powders in some embodiments, can be mixed with SbTe-hydrazine, Te-hydrazine, hydrazine, or other solvents, for instance, within a confined mold and gently heated, in some embodiments in an inert environment or a vacuum. This can drive off the hydrazine and leave behind a SbTe or a Te matrix material between the dried particles, in this example. This process can be repeated until the resultant pellet is dry and consolidated into a monolithic structure with the desired properties, such as a high Seebeck coefficient. Subsequent hot pressing of the material can increase the density of the pellet. However, it may also result in undesired grain growth of the pellet. Other possible matrix materials could further include grain growth inhibitors, which could consist of other semiconductor materials, oxides, nitrides, ceramics, carbon, or other materials that will impede the growth of grains while not overly impacting the electrical performance of the material.

An advantage of this embodiment is that high heat is not applied to the material, and therefore the colloidally grown nanomaterials may remain substantially the same relative size as when they were first used in the powder, i.e., nanoscale. There may be more SbTe matrix material, for example, present in this embodiment due to the fact that it is used as a molecular glue between the nanoparticles. This can result in a larger conduction pathway throughout the material of the pellet, however, which is often desirable for electronic applications.

Other materials may be used as the molecular glue as well, providing that they do not have significant residue that will degrade the overall device performance. For example, metallic nanoparticles may be added to the dry powder and melted at a temperature due to their lower relative melting point. With a low melting point, the temperature may be sufficient to melt the nanometal but not high enough to induce grain growth of the pellet.

In other embodiments, the matrix material may be small particles of semiconductor materials of a given stoichiometry that is mixed with nanocrystals of the same or different stoichiometry in a solvent. Then the material can be dried and consolidated to form a final monolithic material. Examples can include ball milled semiconductor materials as the matrix material while semiconductor nanocrystals can be used as a “glue” to give good electrical conductivity between the particles after the consolidation technique.

Another embodiment includes creating nanocrystals with an abundance of one or more atomic species that is not stoichiometrically ideal for the semiconductor lattice. For example, nanocrystals of Bi_{0.5}Sb_{1.5}Te_{3.5} could be synthesized, where the semiconductor lattice can only incorporate Te_{3.0}, so there is excess Te in the material. In this case, a well-ordered semiconductor lattice will form, especially when heated, and the excess Te will be expelled to the surface of the material as it cannot be fully incorporated into the semiconductor lattice. When mixed with other like particles, this surface Te can act as a molecular glue between the semiconductor nanoparticles. In addition, this material itself can then be used a molecular glue between much larger particles. For instance, nanocrystals of this material with excess Te on the surface can be used as a molecular glue in order to ‘glue’ together ball-milled semiconductor particles.

In other embodiments, a grain growth inhibitor may be added to the nanocrystal powder. This grain growth inhibitor can decrease the end grain size of the material, compared to grain growth which could otherwise occur. Grain growth inhibitors may include, but are not limited to, tungsten, titanium, silver, oxygen, silicon, carbon and zirconium.

In another embodiment, a partial oxidation process may be used. Nanocrystals are notoriously easy to oxidize due to their large relative surface area. However, by consolidating through hot pressing, low temperature pressing, or spark plasma sintering to create a final consolidated material while exposed to at least some environmental air, or through the introduction of at least some oxygen gas, the properties of the material may be enhanced for thermoelectric applications. As described above, it has been found that slight oxidation of the nanocrystals can inhibit the grain growth of the resulting material, thus maintaining more of the quantum confinement properties in the end material. In this case, slight oxidation refers to an amount of oxide built up on the surface that, once consolidated, will not adversely affect performance of the material. This amount may vary depending on the final consolidation method, for instance spark plasma sintering (SPS) may have more tolerance for oxidation than casting the material in a mold via evaporation of the solvents. As such, according to this embodiment, exposure to at least some oxygen during the consolidation process can be beneficial. The oxides created within the material through the oxidation of the nanocrystals may act as a grain growth inhibitor so that nanomaterial properties are preserved, without significantly reducing the quantum confinement affect due to control of the oxidation.

In another embodiment, an electrical current process (similar to arc welding) is utilized for consolidating the material. In this embodiment, electrical current passing through a material will tend to heat the material locally. Depending on the current and resistivity, the material could get hot enough to melt in very local regions of the end material. Further, electrical current always seeks the path of least resistance when traveling through a medium. For example, lighting striking from clouds to the ground does not follow a straight-line path but arcs across the sky in an effort to find the path of least resistance. The same principle is true for a current passing through a powder of semiconductor nanocrystals. Passing a high current through such a powder will act as a consolidation methodology and can result in conductive pathways that run through the material.

This final material is often mechanically strong enough to withstand post processing techniques such as slicing and dicing of the material in order to get a final shaped semiconductor. This method can be applied to a powder as described in the first example above, or to a previously consolidated material, as provided by other embodiments of the present invention, to enhance the electrical conductivity properties of the material. A powder can be cold pressed into a pellet followed by this arc welding technique in order to enhance the electrical conductivity without applying any direct heat. This can be particularly useful for applications where the nanomaterial properties need to be preserved. The method allows for the nanostructure to survive consolidation methodologies, while enhancing the electrical conductivity. Previous methods including general melting techniques, like hot pressing, can be avoided in this embodiment, and in exchange a localized melting can be achieved.

In another embodiment, a final stratified material can be produced. For instance, a desired material for various electronic applications may be a heterostructure, such as a structure consisting of different semiconductor, insulator and/or conductive sections that together provide an optimal performance for the desired application. A method of constructing such a material is disclosed below.

A final, monolithic material can be constructed with any number of layers of constituents within the material. For example, the BiTe—SbTe powder that was discussed in previous embodiments may be added as one layer, which may be followed by another layer of the same material with different grain sizes, or by a different semiconductor material with similar or different grain sizes, or a different molecular glue, as a few examples. Further, subsequent layers may possess metallic dopants. Layers may include an insulating material. The overall layer thickness, as well as each individual layer's thickness, can be varied by adding more or less material before the consolidation of each layer or before the final consolidation. According to certain embodiments, a material can be produced including a final material of a homogeneous layer or a heterogeneous material having any number of constituent layers of various material properties and thicknesses.

These variables can lead to a very robust material technology that has applications across many industries and markets.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of consolidating a material comprising:
mixing a population of semiconductor nanocrystals with a matrix material and a solvent;
heating the mixture to remove the solvent; and
consolidating the semiconductor nanocrystals and the matrix material into a consolidated material.

2. The method of claim 1, wherein the matrix material is a semiconducting material.

3. The method of claim 1, wherein the consolidating utilizes a method chosen from the group consisting of: hot pressing, cold pressing, and applying an electrical current.

4. The method of claim 3, wherein the consolidating is done in the presence of oxygen.

5. The method of claim 1, further comprising:
mixing at least one of the population of semiconducting nanocrystals, the matrix material, or the solvent with a molecular glue.

6. The method of claim 1, further comprising:
mixing at least one of the population of semiconducting nanocrystals, the matrix material, or the solvent with a grain growth inhibitor.

7. The method of claim 1, wherein a concentration of at least one atomic species of the population of nanocrystals is higher than an allowable stoichiometry.

8. The method of claim 7, wherein the at least one atomic species has a higher concentration at a surface of the nano crystals.

9. The method of claim 8, wherein the at least one atomic species acts as an atomic glue between the nanocrystals and at least one of: other nanocrystals of the population of nanocrystals or a population of larger particles.

10. A consolidated material comprising:
a population of semiconductor nanocrystals; and
a matrix material.

11. The consolidated material of claim 10, wherein the matrix material is a semiconducting material.

12. The consolidated material of claim 10, wherein the consolidated material further comprises a molecular glue.

13. The consolidated material of claim 10, wherein the consolidated material further comprises a grain growth inhibitor.

14. The consolidated material of claim 10, wherein a concentration of at least one atomic species of the population of nanocrystals is higher than an allowable stoichiometry.

15. The consolidated material of claim 14, wherein the at least one atomic species has a higher concentration at a surface of the nanocrystals.

16. The consolidated material of claim 15, wherein the at least one atomic species acts as an atomic glue between the nanocrystals and at least one of: other nanocrystals of the population of nanocrystals or a population of larger particles included consolidated material.

17. A consolidated material made by a method comprising:
mixing a population of semiconductor nanocrystals with a matrix material and a solvent;
heating the mixture to remove the solvent; and
consolidating the semiconductor nanocrystals and the matrix material into a consolidated material.

18. The consolidated material of claim 17, wherein the consolidating utilizes a method chosen from the group consisting of: hot pressing, cold pressing, and applying an electrical current.

19. The consolidated material of claim 18, wherein the consolidating is done in the presence of oxygen and the consolidated material further comprises at least some oxide.
